(19) United States
(12) Patent Application Publication
(10) Pub. No.: US 2014/0318492 A1
(43) Pub. Date: Oct. 30, 2014

(54) PISTON FOR AN INTERNAL COMBUSTION ENGINE AND METHOD FOR PRODUCING SAME

(71) Applicant: MAHLE International GmbH, Stuttgart (DE)

(72) Inventors: Timo Linke, Stuttgart (DE); Rainer Scharp, Vaihingen (DE)

(73) Assignee: MAHLE INTERNATIONAL GMBH, Stuttgart (DE)

(21) Appl. No.: 14/360,406

(22) PCT Filed: Nov. 26, 2012
(86) PCT No.: PCT/DE2012/001126

§ 371 Date: May 23, 2014

(30) Foreign Application Priority Data
Nov. 26, 2011 (DE) 10 2011 119527.4

(51) Int. Cl. F02F 3/16

(52) U.S. Cl. CPC F02F 3/16
USPC 123/193.6; 29/888.04

(57) ABSTRACT

A piston for an internal combustion engine has a piston head having a piston crown, and a piston skirt, a first part of the piston head being formed by a piston base, and a second part of the piston head being formed by a piston head element, and a peripheral cooling channel being provided in the piston head. At least one heat-conducting element is arranged in the cooling channel and is connected to the piston base and the piston head element via an external seam and an internal seam which extend from the piston crown to the cooling channel. The invention further relates to a method for producing the piston.

The present invention relates to a piston for an internal combustion engine, having a piston head that has a piston crown, and having a piston skirt, wherein a first part of the piston head is formed by a piston base body, wherein a second part of the piston head is formed by a piston head element, and wherein a circumferential cooling channel is provided in the piston head. The present invention furthermore relates to a method for the production of such a piston.

In modern pistons, the piston head is exposed to great mechanical and thermal stresses, particularly in the region of the piston crown. In this connection, the problem arises that at temperatures above 280° C., the cooling oil present in the circumferential cooling channel is thermally decomposed. In this connection, oil carbon occurs, which settles on the inside walls of the cooling channel. The oil carbon has a heat-insulating effect, so that the cooling output of the cooling oil in the cooling channel is reduced. The task of the present invention therefore consists in further developing a piston of the stated type in such a manner that improved heat dissipation from the piston crown is possible.

The solution consists in that at least one heat-conducting element is disposed in the cooling channel, which element is connected with the piston base body and the piston head element by way of an outer joining seam and an inner joining seam, which run from the piston crown to the cooling channel.

The method according to the invention is characterized by the following method steps: (a) making available a piston base body and a piston head element as well as at least one heat-conducting element; (b) fastening the at least one heat-conducting element to the piston base body or to the piston head element; (c) mounting the piston base body and piston head element in such a manner that an outer joining region and an inner joining region are formed, which run from the piston crown to the cooling channel; (d) joining the piston base body and piston head element in such a manner that an outer joining seam is formed in the outer joining region and an inner joining seam is formed in the inner joining region; (e) reworking and/or finishing the piston.

The piston according to the invention is characterized, particularly as compared with the German patent application 10 2011 115 826.3, in that the heat-conducting element provided according to the invention ensures further improved heat dissipation, proceeding from the piston crown in the direction of the cooling channel. In this way, the risk of oil carbon formation is clearly reduced once again. The further improved heat dissipation furthermore leads to the result that the wall thicknesses of the piston according to the invention and therefore its weight can be reduced, so that it is particularly well suited for those internal combustion engines that reach particularly high speeds of rotation during engine operation. Therefore, the specific output of the engine can also be increased, without thermal problems occurring at the piston.

Advantageous further developments are evident from the dependent claims.

It is practical if the at least one heat-conducting element is configured in one piece, for example as a one-piece ring. Of course, it can also be configured in multiple pieces, for example consisting of individual segments.

Preferably, the at least one heat-conducting element forms an angle of 20° to 70° with the center piston axis with its section that projects into the cooling channel. In this way, the heat generated in the region of the piston crown is dissipated into cooler regions of the cooling channel or of the piston, in targeted manner.

In another preferred further development, the at least one heat-conducting element has slits at least in its section that projects into the cooling channel. These serve to increase the surface area of the at least one heat-conducting element and therefore serve for further improved heat exchange. If the at least one heat-conducting element is supposed to be reshaped so that it forms an angle of 20° to 70° with the center piston axis with its section that projects into the cooling channel, this preferred embodiment with slits further simplifies the bending process.

The outer joining seam preferably runs in a region that extends maximally from the center piston axis to the radial center of the cooling channel. In this embodiment, heat is dissipated, in targeted manner, from the regions of the piston crown that are under the most thermal stress.

It is practical if the at least one heat-conducting element is joined by means of welding or soldering, preferably by means of laser welding.

The piston head element is preferably configured as a piston ring element or as a bowl edge reinforcement of a combustion bowl. This makes it possible to produce the regions of the piston that are under particularly great thermal and mechanical stress from a material particularly well suited for this purpose.

It is practical if the at least one heat-conducting element consists of a material having a high heat conductivity coefficient. Materials on the basis of at least one metal, which can be selected, for example, from the group comprising aluminum, copper, and iron, are preferred. The material can contain graphite, if necessary, for example in order to increase its strength. Fundamentally, the piston base body can be produced from a metallic material, and the piston head element can be produced from a high-strength and/or particularly temperature-resistant material. In this connection, steel materials are preferred.

A further development of the method according to the invention provides that after step (a) or step (b), the at least one heat-conducting element is bent in such a manner that it forms an angle of 20° to 70° with the center piston axis with its section that projects into the cooling channel. In this way, the heat generated in the region of the piston crown is dissipated, in targeted manner, into cooler regions of the cooling channel or of the piston.

A particularly preferred embodiment of the method according to the invention consists in that in step (c), the piston base body and the piston head element are mounted in such a manner that an outer gap covered by the heat-conducting element is formed in the outer joining region, and an inner gap covered by the piston base body or by the piston head element is formed in the inner joining region. During the subsequent joining process, material, for example solder material or welding beads, can collect in these gaps. Furthermore, the cooling channel is additionally shielded from such material by means of covering the gaps. Therefore the material cannot get into the cooling channel and contaminate the coolant during subsequent engine operation. This could lead to engine damage.

In step (d), joining particularly preferably takes place by means of laser welding.

Exemplary embodiments of the present invention will be explained in greater detail below, using the attached drawings. These show, in a schematic representation, not true to scale:

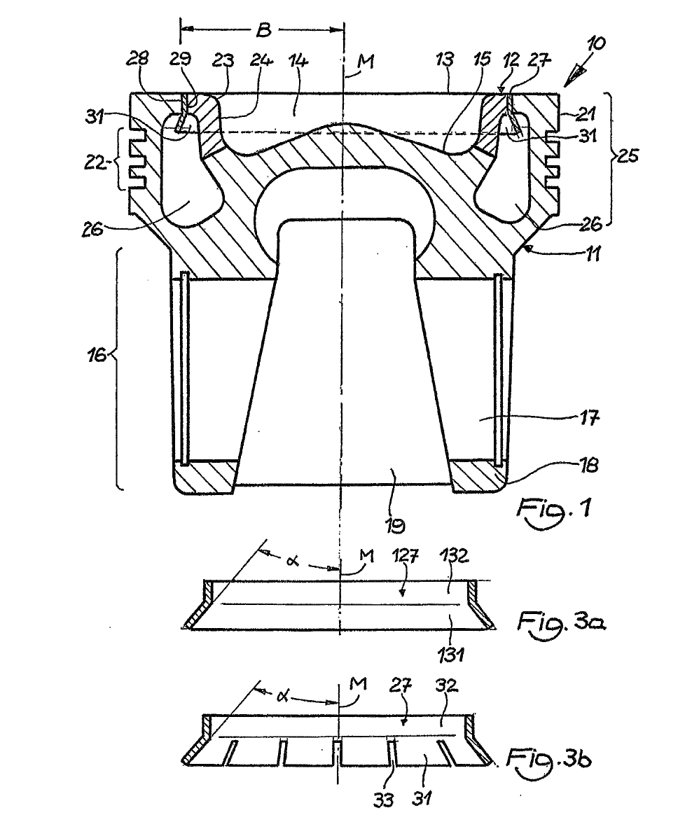

FIG. 1 a first embodiment of a piston according to the invention, in section;

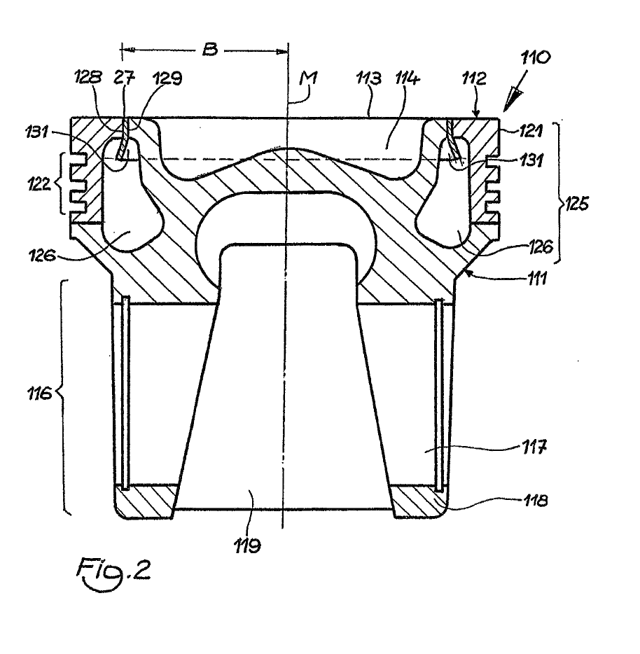

FIG. 2 a further embodiment of a piston according to the invention, in section;

FIG. 3a an individual representation of a first embodiment of a heat-conducting element;

FIG. 3b an individual representation of a further embodiment of a heat-conducting element;

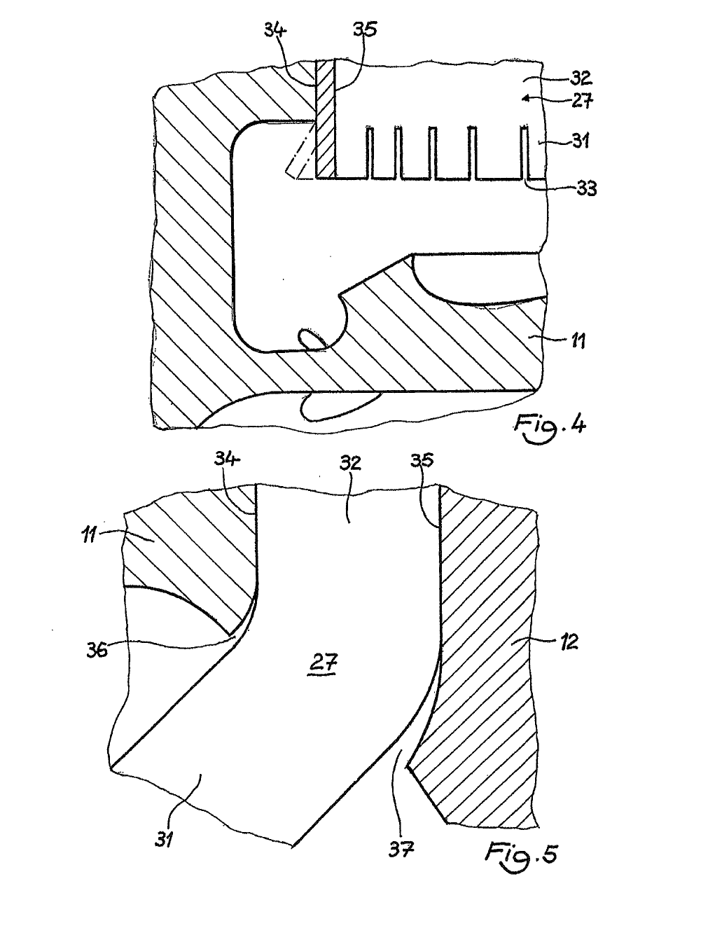

FIG. 4 an enlarged partial representation of an embodiment of a method step of the method according to the invention;

FIG. 5 an enlarged partial representation of an embodiment of a method step of the method according to the invention;

FIG. 1 shows a first exemplary embodiment of a piston 10 according to the invention. The piston 10 has a piston base body 11 and a piston head element 12. In this exemplary embodiment, the piston base body 11 forms the bottom 15 of a combustion bowl 14 as well as part of the piston crown 13. On the underside of the piston crown 13, a piston skirt 16 is connected, in known manner, which skirt has pin bosses 18 provided with pin bores 17, as well as working surfaces 19. The piston base body 11 furthermore forms a circumferential top land 21 as well as a circumferential ring belt 22 with ring grooves for piston rings (not shown). The piston base body 11 can be produced from a steel material, for example.

In this exemplary embodiment, the piston head element 12 forms part of the piston crown 13 as well as the outer bowl edge 23 and the bowl wall 24 of the combustion bowl 14. The piston head element 12 can be produced from a high-strength and/or temperature-resistant steel material, for example.

The piston base body 11 and the piston head element 12 thereby jointly form the piston head 25 of the piston 10. The piston base body 11 and the piston head element 12 furthermore jointly form a circumferential cooling channel 26, approximately at the level of the ring belt 22. The piston base body 11 and the piston head element 12 are connected with one another by means of laser welding in the exemplary embodiment.

In the exemplary embodiment, a heat-conducting element 27 is provided in the cooling channel 26, according to the invention. In this exemplary embodiment, the heat-conducting element 27 is configured as a one-piece ring. Of course, multiple heat-conducting elements in the manner of ring segments can also be provided. The heat-conducting element 27 is produced from a material having a high heat-conductivity coefficient, preferably from a metallic material such as steel or copper, for example. The heat-conducting element 27 is disposed between the piston base body 11 and the piston head element 12, and is connected with these two components by way of an outer joining seam 28 and an inner joining seam 29, in the exemplary embodiment by means of laser welding. In this connection, the outer joining seam 28 and the inner joining seam 29 run from the piston crown 13 to the cooling channel 26. The outer joining seam 28 is furthermore disposed in a region B that extends maximally from the center piston axis M to the radial center of the cooling channel 26.

The section 31 of the heat-conducting element 27 that projects into the cooling channel 26 is bent in the direction of the ring belt 22 in this exemplary embodiment, in such a manner that it encloses an angle α of about 40° C. with the center piston axis M. The angle α preferably varies between 20° and 70°.

FIG. 2 shows a further exemplary embodiment of a piston 110 according to the invention. The piston 110 also has a piston base body 111 and a piston head element 112. In this exemplary embodiment, the piston base body 111 forms part of the piston crown 113 as well as a combustion bowl 114. A piston skirt 116 is connected with the underside of the piston crown 113, in known manner, which skirt has pin bosses 118 provided with pin bores 117 as well as working surfaces 119. The piston base body 111 can be produced from a steel material, for example.

In this exemplary embodiment, the piston head element 112 forms part of the piston crown 113 as well as a circumferential top land 121, and a circumferential ring belt 122 having ring grooves for piston rings (not shown). The piston head element 112 can be produced from a high-strength and/or temperature-resistant steel material, for example.

The piston base body 111 and the piston head element 112 thereby jointly form the piston head 125 of the piston 110. The piston base body 111 and the piston head element 112 furthermore jointly form a circumferential cooling channel 126, approximately at the level of the ring belt 122. The piston base body 111 and the piston head element 112 are connected with one another by means of laser welding in the exemplary embodiment.

In the exemplary embodiment, a heat-conducting element 127 is provided in the cooling channel 126, according to the invention. In this exemplary embodiment, the heat-conducting element 127 is configured as a one-piece ring. Of course, multiple heat-conducting elements in the manner of ring segments can also be provided. The heat-conducting element 127 is produced from a material having a high heat-conductivity coefficient, preferably from a metallic material such as steel or copper, for example.

The heat-conducting element 127 is disposed between the piston base body 111 and the piston head element 112, and is connected with these two components by way of an outer joining seam 128 and an inner joining seam 129, in the exemplary embodiment by means of laser welding. In this connection, the outer joining seam 128 and the inner joining seam 129 run from the piston crown 113 to the cooling channel 126. The outer joining seam 128 is furthermore disposed in a region B that extends maximally from the center piston axis M to the radial center of the cooling channel 126.

The section 131 of the heat-conducting element 127 that projects into the cooling channel 126 is bent in the direction of the ring belt 122 in this exemplary embodiment, in such a manner that it encloses an angle α of about 40° C. with the center piston axis M. The angle α preferably varies between 20° and 70°. FIGS. 3a and 3b show two exemplary embodiments of heat-conducting elements 27, 127. The heat-conducting element 127 according to FIG. 3a has a bent section 131 that projects into the cooling channel 126 of the piston 110 after assembly, and encloses an angle α of about 40° C. with the center piston axis M. Furthermore, the heat-conducting element 127 has an axially directed section 132 that is connected with the piston base body 111 and the piston head element 112 of the piston 110 after assembly, by way of the joining seams 128, 129. The heat-conducting element 127 according to FIG. 3b also has a bent section 31 that projects into the cooling channel 26 of the piston 10 after assembly, and encloses an angle α of about 40° C. with the center piston axis M. Furthermore, the heat-conducting element 27 has an axially directed section 32 that is connected with the piston base body 11 and the piston head element 12 of the piston 10 after assembly, by way of the joining seams 28, 29. The bent section 31 is provided with slits 33 that are disposed axially and run radially around the circumference. The slits 33 serve to increase the surface area of the heat-conducting element 27, in order to increase the heat exchange. Furthermore, the slits 33 simplify bending of the section 31 of the heat-conducting element 27.

In the following, an exemplary embodiment of the method according to the invention, using the example of the piston 10 according to FIG. 1, will be described using FIGS. 4 and 5.

The piston base body 11 and the piston head element 12 are produced separately, in known manner. The heat-conducting element 27 is also produced separately, and provided with slits 33 that are disposed axially and run radially around the circumference, in its section 31, which is still directed axially. The heat-conducting element 27 is fastened onto the piston base body 11 in the region of the subsequent outer joining seam 28 (see FIG. 1) with its section 32, for example tacked on by means of welding or soldering. Thereby an outer joining region 34 is formed between piston base body 11 and heat-conducting element 27, which region runs from the subsequent cooling channel 26 to the subsequent piston crown 13. This phase of the method according to the invention is shown in FIG. 4.

Subsequently, the section 31 of the heat-conducting element 27 is bent radially in the direction of the ring belt 22, in such a manner that the section 31 encloses an angle α of 20° to 70° with the center piston axis M in the finished piston 10, in the exemplary embodiment about 40°.

In the production of the piston 110 according to FIG. 2, this bending process can can also take place before the heat-conducting element 127 is fastened onto the piston base body 111.

Of course, the heat-conducting element 27, 127 can also be fastened onto the piston head element 12, 112.

Now the piston base body 11 together with the heat-conducting element 27 fastened onto it and the piston head element 12 are assembled in such a manner that an inner joining region 35 is formed between the piston head element 12 and heat-conducting element 27, which region runs from the subsequent cooling channel 26 to the subsequent piston crown 13. This phase of the method according to the invention is shown in FIG. 5.

In FIG. 5, it can furthermore be seen that in this exemplary embodiment, the piston base body 11 and the piston head element 12 are assembled in such a manner that an outer, approximately wedge-shaped gap 36, covered by the heat-conducting element 27, is formed in the outer joining region 34, and an inner, approximately wedge-shaped gap 37, covered by the piston head element 12, is formed in the inner joining region 35. During the subsequent joining process by means of laser welding, the outer joining seam 28 is formed in the outer joining region 34, and the inner joining seam 29 is formed in the inner joining region 35. Furthermore, in the exemplary embodiment, weld beads can collect in these gaps 36, 37. Finally, the cooling channel 26 is additionally shielded from entry of weld beads because the gaps 36, 37 are covered, so that weld beads collect in the gaps 36, 37. Therefore no weld beads can get into the cooling channel 26 and contaminate the coolant during subsequent engine operation, which leads to engine damage.

After reworking and/or finishing, the piston 10 according to FIG. 1 is obtained.

1. Piston (10, 110) for an internal combustion engine, having a piston head (25, 125) that has a piston crown (13, 113), and having a piston skirt (16, 116), wherein a first part of the piston head (25, 125) is formed by a piston base body (11, 111), wherein a second part of the piston head (25, 125) is formed by a piston head element (12, 112), and wherein a circumferential cooling channel (26, 126) is provided in the piston head (25, 125), wherein at least one heat-conducting element (27, 127) is disposed in the cooling channel (26, 126), which element is connected with the piston base body (11, 111) and the piston head element (12, 112) by way of an outer joining seam (28, 128) and an inner joining seam (29, 129), which run from the piston crown (13, 113) to the cooling channel (26, 126).

2. Piston according to claim 1, wherein the at least one heat-conducting element (27, 127) is configured in one piece or in multiple pieces.

3. Piston according to claim 1, wherein the at least one heat-conducting element (27, 127) is configured as a one-piece ring.

4. Piston according to claim 1, wherein the at least one heat-conducting element (27, 127) forms an angle (α) of 20° to 70° with the center piston axis (M) with its section (31, 131) that projects into the cooling channel (26, 126).

5. Piston according to claim 1, wherein the at least one heat-conducting element (27) has slits (33) at least in its section (31) that projects into the cooling channel (26, 126).

6. Piston according to claim 1, wherein the outer joining seam (28) runs in a region (B) that extends maximally from the center piston axis (M) to the radial center of the cooling channel (26, 126).

7. Piston according to claim 1, wherein the at least one heat-conducting element (27, 127) is joined by means of welding or soldering.

8. Piston according to claim 1, wherein the piston head element (12) is configured as a bowl edge reinforcement of a combustion bowl (14).

9. Piston according to claim 1, wherein the piston head element (112) is configured as a piston ring element.

10. Piston according to claim 1, wherein the at least one heat-conducting element (27, 127) is produced from a metallic material.

11. Piston according to claim 10, wherein the at least one heat-conducting element (27, 127) is produced from a steel material.

12. Method for the production of a piston (10, 110) for an internal combustion engine, having a piston head (25, 125) that has a piston crown (13, 113), and having a piston skirt (16, 116), wherein a first part of the piston head (25, 125) is formed by a piston base body (11, 111), wherein a second part of the piston head (25, 125) is formed by a piston head element (12, 112), and wherein a circumferential cooling channel (26, 126) is provided in the piston head (25, 125), having the following method steps:
(a) making available a piston base body (11, 111) and a piston head element (12, 112) as well as at least one heat-conducting element (27, 127);
(b) fastening the at least one heat-conducting element (27, 127) to the piston base body (11, 111) or to the piston head element (12, 112);
(c) mounting the piston base body (11, 111) and piston head element (12, 112) in such a manner that an outer joining region (34) and an inner joining region (35) are formed, which run from the piston crown (13, 113) to the cooling channel (26, 126);
(d) joining the piston base body (11, 111) and piston head element (12, 112) in such a manner that an outer joining seam (28, 128) is formed in the outer joining region (34) and an inner joining seam (29, 129) is formed in the inner joining region (35);
(e) reworking and/or finishing the piston (10, 110).

13. Method according to claim 12, wherein after step (a) or step (b), the at least one heat-conducting element (27, 127) is bent in such a manner that it forms an angle (α) of 20° to 70° with the center piston axis (M) with its section (31, 131) that projects into the cooling channel (26, 126).

14. Method according to claim 12, wherein in step (c), the piston base body (11, 111) and the piston head element (12, 112) are mounted in such a manner that an outer gap (36) covered by the heat-conducting element (27, 127) is formed in the outer joining region (34), and an inner gap (37) covered by the piston base body (11, 111) or by the piston head element (12, 112) is formed in the inner joining region (35).

15. Method according to claim 12, wherein in step (d), joining takes place by means of laser welding.
